(19) United States
(12) Patent Application Publication
(10) Pub. No.: US 2016/0297378 A1
(43) Pub. Date: Oct. 13, 2016

(54) VEHICLE CONSOLE COVERING APPARATUS

(71) Applicant: Damon Joseph Humphrey, San Diego, CA (US)

(72) Inventor: Damon Joseph Humphrey, San Diego, CA (US)

(21) Appl. No.: 14/684,375

(22) Filed: Apr. 11, 2015

(51) Int. Cl. B60R 13/02

(52) U.S. Cl. CPC B60R 13/0275; B60R 13/0262

(57) ABSTRACT

A vehicle console covering apparatus for placement on a conventional vehicle center console comprises a top comfort layer disposed on top of non-slip layer and connected around its longitudinal edges to a lower attachment layer, thereby forming a slip cover with an open front end and an open back end and an enclosure between the combined comfort layer and non-slip layer and the attachment layer. The vehicle console covering apparatus is slipped in place on a conventional center console by opening a hinged top of the center console and inserting the hinged top into the open back end until the hinged top is completely enclosed into the vehicle console covering apparatus. The attachment later includes elastic strips on its ends that are not connected to the comfort layer, enabling the vehicle console covering apparatus to stretch open and then contract tightly around the hinged top of the center console.

### BACKGROUND OF THE INVENTION

1. Field of the Invention

This invention relates generally to vehicle accessories and, more particularly, to a covering apparatus for removable placement on the center console of a vehicle.

2. Description of the Prior Art

The use and design of center consoles in conventional automobiles and other vehicles is well known. It is common in such vehicles for the center console to be used as an arm rest. Due to the frequency of use, however, this often leads to the center console becoming worn out with its appearance diminishing the overall aesthetics of the car. Thus, a problem which still exists is that due to their placement and size, center consoles will often experience significant wear and tear on their surface, which often dulls the overall appearance of the interior of the vehicle. Unlike other features which experience significant wear and tear, such as floors, center consoles are typically not covered with replaceable structures (like the floors are with floor mats). Thus, there remains a need for a vehicle console covering apparatus suitable for placement over the center console to improve comfort and durability. It would be helpful if such a vehicle console covering apparatus included a non-slip layer and a comfort layer to improve its ability to remain in place and provide a comfortable surface for a user's arm. It would be additionally desirable for such a vehicle console covering apparatus to include cut out portions so as to not block access to access features of the console, such as buttons, and to allow items to be stored.

The Applicant's invention described herein provides for a vehicle console covering apparatus adapted for placement over a center console in a vehicle to provide a protective and comfortable surface thereon. The primary components in Applicant's vehicle console covering apparatus are a cover body and a securing edge. When in operation, the vehicle console covering apparatus enables the surface of a center console to be protected from damage and wear and tear from use while not restricting the use of the console. As a result, many of the limitations imposed by prior art structures are removed.

### SUMMARY OF THE INVENTION

A vehicle console covering apparatus for placement on a conventional vehicle center console to improve comfort and durability. The vehicle console covering apparatus comprises a top comfort layer disposed on top of non-slip layer and connected around its longitudinal edges to a lower attachment layer, thereby forming a slip cover with an open front end and an open back end and an enclosure between the combined comfort layer and non-slip layer and the attachment layer. The vehicle console covering apparatus is slipped in place on a conventional center console by opening a hinged top of the center console and inserting the hinged top into the open back end until the hinged top is completely enclosed into the vehicle console covering apparatus. The attachment later includes elastic strips on its ends that are not connected to the comfort layer, enabling the vehicle console covering apparatus to stretch open and then contract tightly around the hinged top of the center console.

It is an object of this invention to provide a vehicle console covering apparatus suitable for placement over the center console to improve comfort and durability.

It is another object of this invention to provide a vehicle console covering apparatus that includes a non-slip layer and a comfort layer to improve its ability to remain in place and provide a comfortable surface for a user's arm.

It is yet another object of this invention to provide a vehicle console covering apparatus that includes cut out portions so as to not block access to access features of the console, such as buttons, and to allow items to be stored.

These and other objects will be apparent to one of skill in the art.

### BRIEF DESCRIPTION OF THE DRAWINGS

FIG. 1 is a side perspective view of an exemplary vehicle center console built in accordance with the prior art.

FIG. 2 is a side perspective view of a vehicle console covering apparatus in place on a vehicle center console in accordance with the present invention.

FIG. 3 is a top plan view of a vehicle console covering apparatus built in accordance with the present invention.

FIG. 4 is a front elevational view of a vehicle console covering apparatus built in accordance with the present invention.

FIG. 5 is a bottom plan view of a vehicle console covering apparatus built in accordance with the present invention.

FIG. 6 is a front elevational view of a cross section of a vehicle console covering apparatus built in accordance with the present invention.

### DETAILED DESCRIPTION OF THE INVENTION

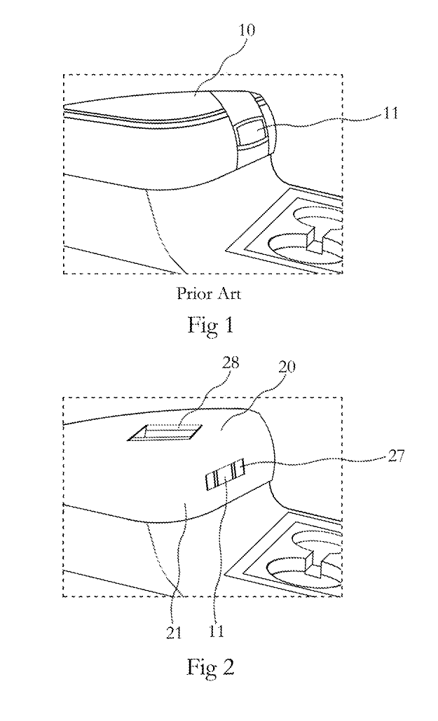

Referring now to the drawings and in particular FIG. 1, a conventional vehicle center console 10 is shown as a console structure positioned between the driver seat and passenger seat of a vehicle. Accordingly, the center console 10 referred to herein refers only to the structure positioned directly between the drivers and passenger seats, not a structure adjacent to the vehicle's dashboard. In many vehicles, the center console 10 is positioned behind the gear stick and/or parking brake, over the transmission tunnel. It is appreciated that many conventional center consoles 10 include hinged top which can be opened to reveal storage space, cup holders, or other vehicle compartments. Such center consoles 10 often have an actuator 11 disposed thereon that releases a latch or locking mechanism which otherwise holds the hinged top in place.

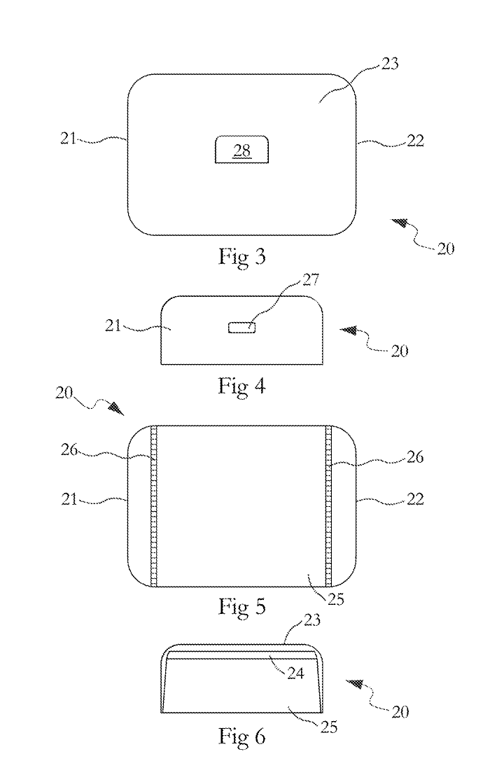

Referring now to FIGS. 1, 2, 3, 4, 5, and 6, a vehicle console covering apparatus 20 defines a slip cover having a open front end 21 and an open back end 22. In the preferred embodiment, the vehicle console covering apparatus 20 includes a top comfort layer 23 disposed on top of non-slip layer 24 and connected around its longitudinal edges to a lower attachment layer 25, thereby forming a two sided enclosure between the combined comfort layer 23 and non-slip layer 24 and the attachment layer 25. Accordingly, the back end 22 is left open as the edge of the comfort layer 23 on the back side of the vehicle console covering apparatus 20 does not connect to the lower attachment layer 25, providing an opening that facilitates the placement of the vehicle console covering apparatus 20 on a center console 10. The front end 21 is left open in the same manner so as to no obstruct any latching mechanism of the center console 10.

It is contemplated that the vehicle console covering apparatus 20 is slipped in place on a conventional center console 10 by opening the hinged top of the center console 10 and inserting the hinged top into the open back end 22 until the hinged top is completely enclosed into the vehicle console covering apparatus 20. The attachment later 25 includes elastic strips 26 on its ends that are not connected to the comfort layer 23 which enables the back end 22 opening to stretch open and then contract tightly around the hinged top of the center console 10 and the front end 21 to provide stretch as need and then contract when the vehicle console covering apparatus 20 is in place on the center console 10 to assist in holding it still.

It is contemplated that when the vehicle console covering apparatus 20 is in place on a center console 10, the top layer 23 will be the outermost layer on top of the center console 10, the non-slip layer 24 will be positioned immediately above the center console 10 and the attachment layer 25 will be positioned under the hinged top of the center console 10. Accordingly, the top layer 23 is constructed of a material desired to improve the comfort of the center console 10 when a user places their arm on it as an arm rest, such as fleece, leather, vinyl, or lamb skin, the non-slip layer is constructed of a material that will resist movement on the center console 10, such as rubber, and the attachment layer 25 is constructed of a thin, durable material, such as a synthetic fabric, that allows the hinged top of the center console 10 to open and close as normal when the vehicle console covering apparatus 20 is in place thereon.

The vehicle console covering apparatus 20 additionally includes a front aperture 27 that is positioned to provide an opening that provides direct access to the actuator 11 on the center console 10 and a top slot 28 for the placement of phones or other items. The top slot 28 defines an aperture in the comfort layer 23 that exposes the non-slip layer 24, enabling items to be placed in a recess on the top surface of the vehicle console covering apparatus 20, directly on top of the non-slip layer 24, to prevent them from moving.

In an non slip on, alternate embodiment, the vehicle console covering apparatus includes a comfort layer on top of a non-slip layer, with the edges of the comfort layer having an elastic band and sized to extending down around the side of a center console. In such an embodiment, no attachment layer is utilized.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A vehicle console covering apparatus for placement on a conventional vehicle center console, comprising:
a slip cover having an front end and a back end and configured to slide onto the vehicle center console, wherein said slip cover includes a comfort layer disposed on a non-slip layer and connected around at least one edge to an least one edge of an attachment layer; and
at least one elastic band integral with said attachment layer, wherein said elastic band is adapted to enable the attachment layer on the back end of the slip cover to be stretched open and automatically contract tightly around the top section of the center console on which the slip cover has been slid onto.

2. The vehicle console covering apparatus of claim 1, wherein the comfort layer includes an aperture that enables items to be placed in a recess on the vehicle console covering apparatus directly on top of the non-slip layer.

3. The vehicle console covering apparatus of claim 1, wherein the front end of the slip cover includes a front aperture configured to provide direct access to the surface of the center console on which the slip cover has been slid onto.

4. The vehicle console covering apparatus of claim 1, wherein the comfort layer is constructed of at least one of as fleece, leather, vinyl, and lamb skin.

5. The vehicle console covering apparatus of claim 4, wherein the non-slip layer is constructed of a rubber.

6. The vehicle console covering apparatus of claim 1, wherein the comfort layer is connected around its edges to edges of the attachment layer so as to form a two sided enclosure.
